(19) United States
(12) Patent Application Publication
(10) Pub. No.: US 2009/0281218 A1
(43) Pub. Date: Nov. 12, 2009

(54) POLYVINYL ESTER DISPERSIONS WITH LOW FILM FORMATION TEMPERATURE AND HIGH WATER RESISTANCE AND USE THEREOF

(75) Inventors: Daniela Hardt, Sulzbach (DE); Hans Uwe Faust, Liederbach (DE)

Correspondence Address: DORITY & MANNING, P.A., POST OFFICE BOX 1449, GREENVILLE, SC, 29602-1449, US

(73) Assignee: Celanese Emulsions GmbH, Kronberg (DE)

(21) Appl. No.: 12/095,374

(22) PCT Filed: Nov. 20, 2006
(86) PCT No.: PCT/EP06/11206

§ 371 Date: Oct. 27, 2008

(30) Foreign Application Priority Data
Dec. 1, 2005 (DE) 10 2005 057 645.1

(51) Int. Cl. C08K 5/09

(52) U.S. Cl. 524/284

(57) ABSTRACT

Polyvinyl ester dispersions with low film formation temperature and high water resistance and use thereof

What are described are polyvinyl ester dispersions having a minimum film formation temperature of less than or equal to 10° C. These comprise a crosslinkable polyvinyl ester dispersion and an ester of aliphatic monocarboxylic acids and at least trihydric aliphatic alcohols and/or an ester of at least tribasic aliphatic carboxylic acids and monohydric aliphatic alcohols as film formation assistants.

These polyvinyl ester dispersions can be used as adhesives with high water resistance.

The invention relates to aqueous polyvinyl ester dispersions which can be used as dispersion-based adhesives with high wet bond strength, to the production of these polymer dispersions and to their use for adhesive bonding, especially of wood and other porous or semi-porous substrates. Polymer dispersions, especially those based on poly(vinyl) esters are used extensively as white glues for the industrial gluing of wood and other porous or semi-porous substrates. When the adhesive bond is expected to be exposed to water after application, these products can also be rendered water-resistant, whether by use of specific crosslinkable or self-crosslinking comonomers during their preparation by emulsion polymerization and/or a subsequent additization by means of specific crosslinkers, frequently in the form of crosslinker resins in combination with crosslinking catalysts. The mode of action consists in attachment of the hydrophilic poly(vinyl) alcohol protective colloid used for colloidal stabilization. In this way, specialty products which satisfy the requirements of relevant standards, for example of DIN EN 204, are obtained.

Cold water-resistant adhesives, for example, for kitchen furniture assembly, have to reach at least the D3 durability class (wet bond strength ≧2 N/mm² after test sequence D3/3 with cold water storage for 4 days).

In the do-it-yourself (DIY) sector too (for example in the gluing of wood block flooring), dispersion-based water-resistant wood adhesives, in particular frequently already based on the D3 quality level, have now become articles for everyday use. Because of the selling times, which are in some cases very prolonged as a result of storage in hardware store warehouses and by the end user, there is a requirement here for the products to have a long shelf life, within which the dispersions must not suffer any quality losses nor increase too greatly in viscosity. The quality demands by the customer also include not just compliance with but significant exceedance of relevant test standards such as DIN EN 204/D3, preferably by 50% to ≧3 N/mm².

A further requirement relates, especially in the central and northern European region, to low film formation temperatures. The aqueous adhesive formulations should have minimum film-formation temperatures (“MFT” hereinafter) of less than or equal to 10° C. It is known that the MFT of a polymer dispersion can be adjusted by adding film formation assistants, also known as coalescents. However, the addition of such agents in some cases has the consequence of deterioration of other properties.

Polymer dispersions based on polyvinyl esters, which are prepared by aqueous emulsion polymerization of vinyl acetate in the presence of polymeric stabilizers (protective colloids), are a mass market product. Overviews of the production and application of poly(vinyl) acetate dispersions can be found in numerous places in the literature, for example in the Handbook of Adhesives (I. Skeist, ed.), 3rd edition, chapter 21.

The patent literature relating to self-crosslinking polymer dispersions, especially poly(vinyl) ester dispersions with methylol monomers, for example, N-methylol (meth)acrylamide or esters thereof, is, as expected, relatively extensive in the adhesives sector. Examples of such polymer dispersions can be found in DE-A-26 20 738, DE-A-39 42628, WO-A-96/36,648 and EP-A-1,170,311. These describe acid-catalyzed crosslinking adhesive systems based on copolymers of vinyl esters with crosslinkable comonomers, including N-methylolacrylamides. According to the disclosure in the working examples, these adhesives give rise to adhesive bonds which satisfy the standard of level EN 204/D3 (or formerly of DIN 68602/B3) with bond strengths of >2 N/mm² in combination with water-soluble strong acids or metal salts thereof, especially salts of Cr(III), Al(III), Fe(III) and Zr(IV).

It is also already known that polyvinyl ester dispersions can be modified by adding esters of polyhydric alcohols, such as triacetin (corresponding to the trisaceticester of glycerol).

For instance, DE-A-41 18 634 describes an aqueous adhesive composition comprising a copolymer based on vinyl acetate, an acrylate and a methyl ether of a polyoxyalkylene allyl alcohol. To control the molecular weight or to improve the properties of the reaction product, it is proposed that selected compounds be added in the polymerization. One example thereof is glyceryl di- or triacetate.

JP-A-63/265,983 describes a hydrophilic adhesive composition with high water resistance and self-adhesive properties. As well as a vinyl acetate dispersion, the composition comprises a selected plasticizer, for example triacetin, and water-absorbing polymer particles, for example of pectin.

EP-A-50,548 describes adhesive dispersions based on polyvinyl acetates stabilized with polyvinyl alcohol. They may comprise plasticizers selected from the group of the classic coalescents for polyvinyl acetates. Examples thereof are dibutyl phthalate, ethylene glycol adipate or dibenzoate, tricresyl phosphate or triphenyl phosphate or triacetin.

DE-A-197 01 235 discloses a process for securing areas of soil. To increase the water resistance of soil impregnations, the use is proposed of emulsion polymers of vinyl monomers, also including vinyl acetate. In one example, the treatment of a sand surface pretreated with a protein adhesive with a triacetin-comprising polyvinyl acetate dispersion is described.

U.S. Pat. No. 3,524,828 describes adhesives comprising selected polyvinyl acetate copolymers, a thickener and a combination of selected plasticizers. One plasticizer component is an ester of glycerol. Triacetin and tributyrin are mentioned by way of example. Crosslinkable polyvinyl acetates are not disclosed.

GB-A-690,299 discloses adhesive compositions for the lamination of metal foils on to paper, which comprise polyvinyl acetate dispersions, plasticizers, casein, a basic nitrogen compound such as ammonia or methylamine, and formaldehyde. One plasticizer mentioned is triacetin. Crosslinking additives and crosslinkable polyvinyl acetates are not disclosed there.

EP-A-705,896 describes remoistenable adhesive compositions comprising polyvinyl acetate dispersions which have been prepared in the presence of a selected polyvinyl alcohol. To increase the speed in the remoistening, it is proposed that triacetin be added to the composition. Crosslinkable polyvinyl acetates are not disclosed.

U.S. Pat. No. 2,628,948 discloses adhesives based on emulsion polymers, preferably polyvinyl acetate dispersions, to which glyceryl esters have been added to improve the water resistance. Examples mentioned are diacetin and triacetin. Crosslinkable polyvinyl esters are not disclosed.

WO-A-98/03,604 discloses aqueous dispersion-based adhesives based on polyvinyl acetate. They may comprise film formation assistants. Mention is made of ethers and/or esters derived from dihydric alcohols or from dicarboxylic acids. As a typical film formation assistant, butyldiglycol acetate is mentioned.

U.S. Pat. No. 4,634,727 describes dispersion-based adhesives based on polyvinyl acetate. As possible additives, phenol-formaldehyde resins, melamine resins, acrylate dispersions or rubber latex are mentioned.

WO-A-00/02,967 describes aqueous pigment-containing polymer formulations. Possible film formation assistants mentioned include a wide variety of different plasticizers. They are typically alkylene glycols, ethers thereof and/or esters thereof and the alkyl esters of aliphatic mono- and dicarboxylic acids.

EP-A-554,747 discloses two-component coating compositions based on polyurethane. As well as a polyol component which has been formed from a high molecular weight polyol and from a reactive diluent and has been dissolved and/or dispersed in water, they comprise a polyisocyanate component present in emulsified form in the aqueous solution and/or dispersion. The polyols used are compounds with chemically incorporated quaternary ammonium groups. This document states that, in the quaternization, small amounts of high-boiling solvents which may also act as coalescents can be used. A list of possible solvents also includes glyceryl triacetate.

DE-T-600 04 914 describes a cosmetic formulation which is used in the field of care and of decoration of keratin fibers. The use of polymers with a star-shaped structure is disclosed. These may be formed from a wide variety of different monomer classes and are combined with customary assistants required for cosmetic compositions, also including film formation assistants. A list of possible film formation assistants includes, among other compounds, also glyceryl diacetate and glyceryl triacetate. This document does not contain any indication that the cosmetic formulations can also be used as adhesives.

None of the publications mentioned gives any information as to how an adhesive formulation with low MFT and simultaneously high water resistance can be produced.

It was accordingly an object of the invention to provide an adhesive based on an aqueous polymer dispersion, said adhesive firstly having a low MFT and secondly having a high cold water resistance of at least 3 N/mm² (determined to DIN EN 204 D3).

Preferred adhesive formulations should additionally pass the creep test according to British Standard 3544 (BS 3544) and/or have a thermal stability of at least 7 N/mm² (determined to WATT 91 (Wood Adhesives Temperature Test)).

Furthermore, the inventive products should be sufficiently storage-stable, and preferably have an ICI gel strength of at most 50 scale divisions, determined after storage at 50° C. for 20 days with the ICI gel strength tester from Sheen Instruments, Ltd.

It has now been found that, surprisingly, this object is achieved by an aqueous and crosslinkable polyvinyl ester dispersion to which a selected coalescent has been added.

The present invention provides a polyvinyl ester dispersion having a minimum film formation temperature of less than or equal to 10° C., preferably less than or equal to 6° C. and especially from 0 to 6° C., comprising a polymerized and/or added crosslinker and a film formation assistant selected from the group of the esters of aliphatic monocarboxylic acids and at least trihydric aliphatic alcohols and/or of the esters of at least tribasic aliphatic carboxylic acids and monohydric aliphatic alcohols.

The emulsion polymer for these polymer dispersions, which forms the basis to the inventive dispersion-based adhesives and is prepared by means of free-radical emulsion polymerization, is formed predominantly on the basis of vinyl esters as the main monomer basis.

The vinyl ester polymers used in accordance with the invention are homo- or copolymers which are rendered crosslinkable. The homo- or copolymers may comprise crosslinkable groups in the molecule or the vinyl ester homo- or copolymer may be combined with crosslinking additives. In the latter case, the vinyl ester homo- or copolymer need not necessarily have polymerized crosslinkable groups.

Useful monomers for the vinyl ester polymers (also referred to as “polyvinyl esters”) used in accordance with the invention include vinyl formate, vinyl acetate, vinyl propionate, vinyl isobutyrate, vinyl pivalate, vinyl 2-ethylhexanoate, vinyl esters of saturated branched monocarboxylic acids having from 9 to 11 carbon atoms in the acid radical, vinyl esters of relatively long-chain saturated or unsaturated fatty acids, for example, vinyl laurate and vinyl stearate, and vinyl esters of benzoic acid and substituted derivatives of benzoic acid such as vinyl p-tert-butylbenzoate. Among these, however, vinyl acetate is particularly preferred. The vinyl esters mentioned can be used individually in the poly(vinyl ester) or else be present alongside one another in a mixture in a copolymer. The proportion of the vinyl esters from this group in the polymer is at least 50% by weight, preferably at least 75% by weight.

The crosslinkers used in the polyvinyl ester may be small amounts of polymerized reactive and self-crosslinking monomers, such as N-methylolacrylamide, N-methylolmethacrylamide or N-methyl ethers thereof.

The crosslinkable polyvinyl ester dispersions which contain reactive monomers as crosslinkers in the polymer skeleton, for example N-methylol groups, can be combined with low molecular weight crosslinkers and/or with crosslinker resins. Examples of such additives are formaldehyde resins from the group of the resorcinol-formaldehyde resins, the urea-formaldehyde resins, the melamine-formaldehyde resins, the phenol-formaldehyde resins, the polyalkoxyalkyl- and polyalkanoldiazines, -triazines and -tetrazines, the imidazolidinones, the thioimidazolidinones, the hydroxymethyl-substituted imidazolidinones, the hydroxymethyl-substituted pyrimidinones, the hydroxymethyl-substituted triazinones or the self-condensation products or mixed condensates thereof, the derivatives from the group of the hydroxymethylated cyclic ethyleneureas which have been at least partly etherified with one or more alkanols, the cyclic propyleneureas, the bicyclic glyoxal diureas or the bicyclic malonaldehyde diureas. Adhesives comprising the latter group of crosslinkers are disclosed in DE-A-103 35 673.

Examples of further preferred crosslinkers are ethoxylated hexahydrotriazines, [2,4,6-[N,N-bis(2-ethylhexyl)methyleneoxy]-N,N′, N″-tris [ethoxypoly-(ethyleneoxy)-methylene]-N″-methoxymethylenetriazine], tetra-methyl ureas, hexakis-(methoxymethyl)melamine, 1,3-bis(hydroxymethyl)-4-methoxy-4,5,5-trimethyl-2-imidazolidinone, N,N′-dimethylol-4-methoxy-5,5-dimethylpropyleneurea, N,N′,N″,N″,N″′-tetrakis(hydroxymethyl)glycoluril, 4,5-dihydroxy-1,3-bis (methoxymethyl)-2-imidazolidinone, 4,5-dihydroxy-1,3-bis(hydroxymethyl) imidazolidine-2-one, tetrahydro-1,3-bis(hydroxymethyl)-4-methoxy-5,5-dimethylpyrimidine-2(1H)-one, 4,5-dihydroxy-1,3-dimethylol-2-imidazolidinone, 4,5-dihydroxy-1,3-dimethyl-2-imidazolidinone, tetra-hydro-1,3-bis(hydroxymethyl)-4-hydroxy-5,5-dimethyl-(1 H)-pyrimidine-2-one (=1,3-dimethylol-4-methoxy-5,5-dimethylpropyleneurea), tetrahydro-1,3-bis(hydroxymethyl)-4-alkoxy-5,5-dimethyl-(1H)-pyrimidine-2-one, and N,N′,N″,N″′-tetrakis(hydroxymethyl)glycoluril.

Where the polyvinyl ester dispersion contains crosslinkable groups in the polymer skeleton, they are generally N-alkylol groups, preferably N-C₁₋₃ alkylol groups. Examples of monomers for copolymerization with the vinyl ester are N-methylol(meth)acrylamide, N-methylol(meth)acrylamide, N-ethanol(meth)acrylamide, N-propanol(meth)acrylamide, N-methylolallyl carbamate, N-methylolmaleamide, N-methylolmaleamic acid, and the N-methylolamides of aromatic vinylcarboxylic acids, for example N-methylol-p-vinylbenzamide. The N-methylolamides of acrylic acid and methacrylic acid are particularly preferred. The proportion of these comonomers in the total amount of monomers is up to 10% by weight, preferably from 0.01 to 5% by weight, especially from 0.05 to 2% by weight. Particularly suitable comonomers are further nitrogen-containing comonomers with N-functional groups, including especially N-ethanol(meth)acrylamide, N-propanol(meth)acrylamide, (meth)acrylamide, allyl carbamate, acrylonitrile, the N-methylol esters, the N-methylol alkyl ethers or Mannich bases of N-methylol(meth)acrylamide or N-methylolallyl carbamate, acrylamidoglycolic acid and/or salts thereof, methyl acrylamidomethoxyacetate, N-(2,2-dimethoxy-1-hydroxyethyl)acrylamide, N-dimethylaminopropyl(methyacrylamide, N-methyl(meth)acrylamide, N-butyl(meth)acrylamide, N-cyclohexyl(meth)acrylamide, N-dodecyl(meth)-acrylamide, N-benzyl(meth)acrylamide, p-hydroxyphenyl(meth)acrylamide, N-(3-hydroxy-2,2-dimethylpropyl)methacrylamide, ethylimidazolidone methacrylate, N-vinylformamide, or N-vinylpyrrolidone. The proportion of these comonomers in the total amount of monomers is up to 15% by weight, preferably up to 10% by weight.

Further ethylenically unsaturated monomers which can be copolymerized with the vinyl esters are α,β-unsaturated acids, for example, acrylic acid, methacrylic acid, and their esters with primary and secondary saturated monohydric alcohols having from 1 to 32 carbon atoms, for example, methanol, ethanol, propanol, butanol, 2-ethylhexyl alcohol, cycloaliphatic or polycyclic alcohols and relatively long-chain fatty alcohols. In addition it is also possible to use α,β-unsaturated dicarboxylic acids, for example, maleic acid, fumaric acid, itaconic acid or citraconic acid, and the mono- or diesters thereof with saturated monohydric aliphatic alcohols having from 1 to 28 carbon atoms. The proportion of these comonomers in the total amount of monomers is up to 25% by weight, preferably up to 15% by weight.

Suitable comonomers are also ethylenically unsaturated hydrocarbons, such as ethylene or α-olefins having 3-28 carbon atoms, for example propylene or butylene, and also styrene, vinyltoluene, vinylxylene and halogenated unsaturated aliphatic hydrocarbons, for example vinyl chloride, vinyl fluoride, vinylidene chloride, vinylidene fluoride. The proportion of these comonomers in the total amount of monomers is up to 50% by weight, preferably up to 25% by weight.

In addition to or instead of the monomers which have an N-methylol group and have already been mentioned, it is possible to use further monomers which typically increase the internal strength of the films of the polymer matrix, and which have at least one epoxy, hydroxyl or carbonyl group, or which have at least two nonconjugated ethylenically unsaturated double bonds. Examples of the latter group are monomers having two vinyl radicals, monomers having two vinylidene radicals and monomers having two alkenyl radicals. Particularly advantageous in this context are the diesters of dihydric alcohols with α,β-monoethylenically unsaturated monocarboxylic acids, among which acrylic acid and methacrylic acid are preferred. Examples of such polyethylenically unsaturated, and hence crosslinking, monomers are diallyl phthalate, diallyl maleate, diallyl fumarate, triallyl cyanurate, triallyl isocyanurate, tetraallyloxyethane, divinylbenzene, alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate, and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, butanediol 1,4-dimethacrylate, or triethylene glycol dimethacrylate; divinyl adipate, allyl (meth)acrylate, vinyl (meth)acrylate, cyclopentadienyl acrylate, vinyl crotonate, methylenebisacrylamide, hexanediol diacrylate, pentaerythritol diacrylate and trimethylolpropane triacrylate, or mixtures of two or more of the compounds from this group may be present in the polymer. The proportion of these comonomers in the total amount of monomers is up to 10% by weight, preferably up to 2% by weight.

Further particularly suitable comonomers are hydroxy-functional monomers such as hydroxyethyl (meth)acrylate, hydroxypropyl (meth)acrylate and adducts thereof with ethylene oxide or propylene oxide. The proportion of these comonomers in the total amount of monomers is up to 25% by weight, preferably up to 15% by weight.

Particularly suitable comonomers are also comonomers which are crosslinkable via carbonyl groups or are self-crosslinking from the group of diacetoneacrylamide, allyl acetoacetate, vinyl acetoacetate and acetoacetoxyethyl (meth)acrylate. The proportion of these comonomers in the total amount of monomers is up to 10% by weight, preferably up to 5% by weight.

A further group of comonomers is that of monomers from the group of unsaturated sulfonic acids and salts thereof, preferably vinylsulfonic acid, 2-acrylamido-2-methylpropanesulfonic acid, epoxy-functional comonomers such as glycidyl methacrylate and glycidyl acrylate, the silicon-functional comonomers such as acryloyloxypropyltri(alkoxy)- and methacryloyloxy-propyltri(alkoxy)silanes, vinyltrialkoxysilanes and vinylmethyldialkoxy-silanes, where the alkoxy groups present may, for example, be ethoxy and ethoxypropylene glycol ether radicals. The proportion of these comonomers in the total amount of monomers is up to 10% by weight, preferably up to 5% by weight.

The proportion of the comonomer units present in the polymer in addition to the vinyl ester units is, in total, up to 50% by weight.

The polymer dispersion comprises, as a stabilizer, at least one protective colloid and/or at least on emulsifier.

An example of a suitable protective colloid is polyvinyl alcohol, especially polyvinyl alcohol with a degree of hydrolysis of 60-100 mol %, preferably from 70 to 98 mol %, and viscosities of the 4% by weight aqueous solutions at 20° C. of from 2 to 70 mpa*s. Also suitable are functional polyvinyl alcohols such as the formal copolymers of vinyl alcohol and optionally of vinyl acetate with ethene, with vinyl acetoacetate or isopropenyl alcohol, or those with carboxyl groups or alkoxysilane groups. In addition, the protective colloids used may be etherified cellulose derivatives, for example hydroxyethylcellulose, hydroxypropylcellulose or carboxymethylcellulose. These may be used either alone or in combination with polyvinyl alcohol. Likewise suitable are polyvinylpyrrolidone, polycarboxylic acids such as polyacrylic acid, and copolymers of maleic acid or of maleic anhydride with ethylenically unsaturated compounds such as methyl vinyl ether or styrene. Also suitable are polyalkylene glycols or the alkali metal salts of polyacrylic acids and polymethacrylic acids, starch and gelatin derivatives, copolymers containing 2-acrylamido-2-methylpropanesulfonic acid and/or 4-styrenesulfonic acid and the alkali metal salts thereof, but also homo- and copolymers containing N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amine-bearing acrylates, methacrylates, acrylamides and/or methacrylamides. A comprehensive description of further suitable protective colloids can be found in Houben-Weyl, Methoden der organischen Chemie [Methods of Organic Chemistry], volume XIV/1, Makromolekulare Stoffe [Macromolecular compounds], Georg-Thieme-Verlag, Stuttgart, 1961, pages 411 to 420. Preference is given to the predominant use of polyvinyl alcohol. Based on the total amount of the monomers, the proportion of the protective colloids is preferably from 1 to 20% by weight, especially from 2 to 14% by weight.

In addition to or instead of the protective colloids, it is also possible to use up to 5% by weight, based on the total amount of the monomers, of nonionic and/or ionic emulsifiers as stabilizers in the inventive polymer dispersion. Compounds suitable for this purpose can be found in relevant compilations known to those skilled in the art, for example the Surfactant Applications Directory (D. R. Karsa et al., Ed., Blackie, London 1991) or in Houben-Weyl, Methoden der organischen Chemie, volume XIV/1, Makromolekulare Stoffe, Georg-Thieme-Verlag, Stuttgart, 1961, pages 190 to 208.

The inventive polymer dispersion comprises at least one film formation assistant (coalescent) which is selected from the group of the esters of aliphatic monocarboxylic acids and at least trihydric aliphatic alcohols and/or esters of at least tribasic aliphatic carboxylic acids and monohydric aliphatic alcohols.

The esters of aliphatic monocarboxylic acids and at least aliphatic trihydric alcohols may be esters in which all or only some of the alcohol groups have been esterified.

The aliphatic monocarboxylic acids used may be saturated or unsaturated monohydric carboxylic acids. Examples thereof are C₁-C₂₀-alkylcarboxylic acids or C₂-C₂₀-alkenylcarboxylic acids. These acids may also be substituted, for example, by halogen atoms, hydroxyl groups or amino groups. The alkyl or alkenyl radicals of these acids may be straight chain or branched. Examples of carboxylic acids are formic acid, acetic acid, alpha-chloroacetic acid, alpha-hydroxyacetic acid, propionic acid, butyric acid, lauric acid, oleic acid or stearic acid. Preference is given to using fatty acids having from one to six carbon atoms, especially acetic acid.

The aliphatic alcohols used may be compounds having at least three hydroxyl groups. The alcohol groups may be primary, secondary and/or tertiary alcohol groups. In addition to the alcohol groups, further functional groups may be present, for example carboxyl groups, ester groups or keto groups.

At least trihydric alcohols have preferably three, four, five or six hydroxyl groups.

Preference is given to at least trihydric aliphatic alcohols having from three to eight carbon atoms.

Examples of such compounds are trimethylolpropane, glycerol, pentaerythritol, sorbitol or carbohydrates, such as aldoses or ketoses.

Particular preference is given to using diesters or especially triesters of glycerol with acetic acid, propionic acid or butyric acid. Very particular preference is given to using the tributyric ester of glycerol (tributyrin) or the triacetic ester of glycerol (triacetin).

The esters of at least tribasic aliphatic carboxylic acids and monohydric aliphatic alcohols may be esters in which all or only some of the carboxyl groups have been esterified.

The monohydric aliphatic alcohols used may be saturated or unsaturated compounds. Examples thereof are the C₁-C₂₀-alkyl monohydroxyl compounds or C₂-C₂₀-alkenyl monohydroxyl compounds. The alcohol groups may be primary, secondary and/or tertiary alcohol groups. These alcohols may also be substituted, for example, by halogen atoms, carboxyl groups or amino groups. Preference is given to using monohydric aliphatic alcohols having from one to six carbon atoms especially methanol, ethanol, propanol or butanol. Further examples of monohydric alcohols are hexanol, lauryl or stearyl alcohol, oleyl alcohol or lactic acid.

The aliphatic carboxylic acids used may be compounds having at least three carboxyl groups. As well as these, further functional groups may be present, for example hydroxyl groups, amino groups or keto groups.

At least trihydric carboxylic acids preferably have three or four carboxyl groups.

Examples of such compounds are butane tetracarboxylic acid or preferably citric acid.

Particular preference is given to using mono-, di- or trialkyl esters, especially mono-, di- or trimethyl esters of citric acid.

The polymer dispersion may comprise, as well as the polymer and the film formation assistant to lower the MFT, also further customary additives, for example plasticizers, defoamers, fillers and preservatives.

The inventive polymer dispersion may comprise free acids, or preferably acidic metal salts, as crosslinking catalysts. Suitable substances for this purpose are salts with polyvalent complexible cations, as detailed, for example, in DE-B 22 61 402, DE-C 26 20 738 and DE-A 39 42 628. Preference is given to using the water-soluble metal salts of Al(III) or Zr(IV), especially aluminum chloride, aluminum nitrate, and zirconium oxychloride, zirconium nitrate. To improve the water resistance, in addition, further salts or additives, for example magnesium chloride, organic and/or inorganic acids such as citric acid, glycolic acid or acidic inorganic salts, for example sodium tetrafluoroborate, can also be used.

The pH range optimal for the crosslinking is preferably between 2 and 6, especially between 2.5 and 4. A suitable pH may also have been attained after the emulsion polymerization, or it may, as is preferred, be established subsequently by addition of the abovementioned acidic compounds.

The solids content of the inventive polymer dispersion is preferably from 20 to 65% by weight, especially from 30 to 63% by weight.

The content of film formation assistant is preferably selected such that the predefined MFT is attained. Typical contents of film formation assistants vary within the range from 0.1 to 20% by weight, preferably from 2 to 15% by weight, most preferably from 3 to 10% by weight, based on the total amount of polymer and protective colloid.

A preferred embodiment of the inventive polymer dispersion comprises
a) a polyvinyl ester homo- or copolymer, preferably a polyvinyl acetate homo- or copolymer, which comprises 0.001-5% by weight, preferably 0.01-3% by weight, of added crosslinker, preferably of added crosslinker resin, and/or 0.001-5% by weight, preferably 0.01-3% by weight, of polymerized structural units derived from monomers having crosslinkable groups,
b) 1-20% by weight, based on the polyvinyl ester homo- or copolymer, of a protective colloid, preferably poly (vinyl alcohol),
c) from 3 to 10% by weight, based on the sum of components a) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6, preferably from 2.5 to 4.

A further preferred embodiment of the inventive polymer dispersion comprises
a) a polyvinyl ester homo- or copolymer, preferably a polyvinyl acetate homo- or copolymer, which comprises 0.001-5% by weight, preferably 0.01-3% by weight, of polymerized structural units derived from monomers having N-methylol groups,
a′) optionally 0.001-5%, preferably 0.01-3%, by weight of crosslinker which reacts with the N-methylol groups,
b) 1-20% by weight, based on the polyvinyl ester homo- or copolymer, of a protective colloid, preferably poly (vinyl alcohol),
c) from 3 to 10% by weight, based on the sum of components a), a′) and and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6, preferably from 2.5 to 4.

A further preferred embodiment of the inventive polymer dispersion comprises
a) a polyvinyl ester homo- or copolymer, preferably a polyvinyl acetate homo- or copolymer, which optionally contains 0.001-5% by weight of polymerized structural units derived from monomers having N-methylol groups,
a′) 0.001-5%, preferably 0.01-3%, by weight of masked polyisocyanate or of masked polyfunctional aldehyde,
b) 1-20% by weight, based on the polyvinyl ester homo- or copolymer, of a protective colloid, preferably poly (vinyl alcohol),
c) from 3 to 10% by weight, based on the sum of components a), a′) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6, preferably from 2.5 to 4.

Adhesives comprising masked polyisocyanates are described in EP-A-206,059. Adhesives comprising masked polyfunctional aldehydes are described in EP-A 686,682.

A further particularly preferred embodiment of the inventive polymer dispersion comprises
a) a polyvinyl ester homo- or copolymer, preferably a polyvinyl acetate homo- or copolymer, which comprises 0.001-5% by weight, preferably 0.01-3% by weight, of polymerized structural units derived from monomers having crosslinkable N-methylol groups, preferably N-methylol(meth)acrylamide,
a′) 0.001 to 1% by weight, based on the amount of polymer dispersion, of an additive which reacts with the crosslinkable N-methylol groups,
b) 1-20% by weight, based on the polyvinyl ester homo- or copolymer, of a protective colloid, preferably poly (vinyl alcohol),
c) from 3 to 10% by weight, based on the sum of components a), a′) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6, preferably from 2.5 to 4.

The inventive polymer dispersion is prepared by the emulsion polymerization process, wherein the polymerization temperature is generally from 40 to 100° C., preferably from 60 to 90° C., especially 62° C.-85° C. The polymerization is initiated with the initiators or redox initiator combinations customary for emulsion polymerization, for example hydroperoxides such as tert-butyl hydroperoxide, azo compounds such as azobisisobutyronitrile, inorganic initiators such as the sodium, potassium and ammonium salts of peroxodisulfuric acid. The initiators mentioned are used generally in an amount of from 0.05 to 3.5% by weight, based on the total weight of the monomers. The redox initiators used optionally are combinations of the initiators mentioned in combination with reducing agents such as sodium sulfite, sodium hydroxymethanesulfinate or ascorbic acid. The amount of reducing agent is preferably from 0.01 to 5.0% by weight, based on the total weight of the monomers.

The polymerization mixture is stabilized predominantly by means of the protective colloids mentioned, if appropriate using, preferably without using, additional emulsifiers. The protective colloid fraction and any emulsifier fraction are preferably partly initially charged. However, the protective colloids and any emulsifiers can also be added before, during or after the polymerization. The monomers can be initially charged in their entirety, metered in in their entirety or initially charged in proportions, and the remainder can be metered in after the polymerization has been initiated.

On completion of the polymerization, to remove residual monomers, polymerization can be continued employing known methods, for example by means of continued polymerization initiated with redox catalyst. Volatile residual monomers can also be removed by means of distillation, preferably under reduced pressure, and optionally while passing inert entraining gases through or over, such as air, nitrogen or steam.

On completion of the polymerization and any demonomerization, this dispersion is then admixed with one of the above-described coalescents and if appropriate further additives, such as acidic metal salts and/or acids in a sufficient amount to establish the suitable pH and if appropriate cross-linking additives. In the course of formulation, the polymer dispersion may be admixed with still further additives, for example plasticizers, defoamers, fillers and preservatives. Within the context of this invention, any combinations with regard to the sequence of additions are permissible.

The inventive polymer dispersions have a low film formation temperature and excellent cold water stability and storage stability. Surprisingly, the polymer dispersions have a very high thermal resistance and pass the creep test to BS 3544, even though the film formation assistants added have comparatively high boiling points of significantly more than 200° C. (at standard pressure).

The invention further provides for the use of the inventive dispersion-based adhesive for adhesive-bonding and coating of substrates of all kinds, or as a water-resistant binder, preferably for adhesive bonding of porous and semi-porous substrates, such as wood, paper or board.

The specific suitability of the inventive polymer dispersion lies in its use as a cold water-resistant adhesive, especially for cellulosic substrates such as wood. The adhesives are suitable for the DIY sector or as an industrial adhesive for machine gluing, and also especially for applications in which the adhesive joints are hardened by high-frequency alternating currents. They are particularly suitable in requirements in which cold water-resisting adhesives with a relatively demanding profile of requirements have to be used.

Further general application examples are water-resistant bonds of paper, board, corrugated board, foam, cement, leather, textile or compressed layer substances.

Other applications lie in adhesives for the construction sector as a floor, wall or roof adhesive, or as a furniture film or carpet backing adhesive.

Further areas of suitability lie in water-resistant binders for wood fiberboard or reconstituted leather, and binders for insulating materials composed of paper or polymer fibers, and also in water-resistant building material dispersions as binders for plaster or cement. A further field of use is as a binder for textiles and nonwovens, and in textile printing and as a textile finish.

The invention further provides for the use of esters of aliphatic monocarboxylic acids and at least trihydric aliphatic alcohols and/or of esters of at least tribasic aliphatic carboxylic acids and monohydric aliphatic alcohols as a film formation assistant for adjusting the minimum film formation temperature of polymer dispersions, especially of polyvinyl ester dispersions.

The invention is described in detail hereinafter with reference to working examples, but without being restricted in any way as a result. The parts and percentages reported in the examples are based on weight, unless stated otherwise.

### COMPARATIVE EXAMPLES 1, 2 AND 3

Commercial adhesive formulations based on polyvinyl acetate dispersions stabilized with polyvinyl alcohol as the protective colloid and containing polymerized N-methylolacrylamide radicals were mixed with commercial coalescents and studied for their storage stability. In addition, adhesive bonds were produced.

The test specimens were produced by the procedure of DIN EN 205. The gluing and testing were carried out with reference to the following characteristic data:

| | |
|---|---|
| Glue application: | 150 ± 20 g/m², both sides |
| Open wait time: | 3 minutes |
| Closed wait time: | 3 minutes |
| Pressing time: | 2 hours |
| Pressure: | 0.7 ± 0.1 N/mm² |
| Number of test specimens | 10 |
| per test cycle | |
| Testing after | 7 days under standard conditions* |
| Storage sequence according | 4 days in cold water (20 +/− 5° C.) |
| to DIN EN 204 D3/3: | |
| Test temperature: | 23°C. ± 2° C. |
| Advance rate: | 50 mm/min |

*23 ± 2° C. and 50 ± 5% relative air humidity

The results of the study of a few performance properties can be found in Table 1.

In comparative example 1 (CE1), Mowilith® LDL 2555W (commercial product from Celanese Emulsions GmbH) was used. This product was a polyvinyl acetate dispersion with polymerized N-methylolacrylamide radicals. This product contained typically 4.4% by weight, based on the sum of polymer and protective colloid, of butyldiglycol acetate (BDGA). In comparative example 2 (CE2) Mowilith® SHP 3 (commercial product from Celanese Emulsions GmbH) was used. This product was a polyvinyl acetate dispersion with polymerized N-methylolacrylamide radicals, to which an external crosslinker had been added. This product contained typically 4.8% by weight, based on the sum of polymer and protective colloid, of BDGA.

In comparative example 3 (CE3), a polymer system corresponding to Mowilith® SHP 3 was used, but without the film formation assistant. Instead of BDGA, this product was admixed with 8% by weight, based on the sum of polymer and protective colloid, of Texanol (commercial film formation assistant based on pentanediol isobutyrate).

### EXAMPLE 1

Commercial adhesive formulations based on polyvinyl acetate dispersions stabilized with polyvinyl alcohol as the protective colloid and comprising polymerized N-methylolacrylamide radicals were tested for their storage stability. In addition, they were used—as described in the comparative tests—to produce adhesive bonds, and some performance properties were studied. The results can likewise be found in Table 1.

In example 1 (E1) a polymer system corresponding to Mowilith® SHP 3 was used, but without the film formation assistant. Instead of BDGA, this product was admixed with 8% by weight, based on the sum of polymer and protective colloid, of triacetin.

TABLE
Results of the performance study

| Property | CE1 | CE2 | CE3 | E1 |
|---|---|---|---|---|
| Solids content (%) | 50.3 | 50.3 | 51 | 51 |
| Viscosity after | 16 200 | 12 900 | 13 700 | 12 650 |
| formulation¹⁾ | | | | |
| [m*Pas] | | | | |
| ICI gel strength²⁾ | 3 | 2 | 2 | 1 |
| after formulation | | | | |
| ICI gel strength²⁾ | 29 | 25 | 27 | 29 |
| after 5 days | | | | |
| ICI gel strength²⁾ | 65 | 59 | 38 | 38 |
| after 10 days | | | | |
| ICI gel strength²⁾ | 81 | 89 | 43 | 42 |
| after 20 days | | | | |
| MFT (° C.) | 6 | 5 | 5.5 | 5.5 |
| D 3/3 (N/mm²)³⁾ | 2.7 | 3.5 | 3.1 | 4.2 |
| Creep test to | passed | not | failed | passed |
| BS 3544 | | determined | | |
| WATT 91⁴⁾ | 7.0 | 6.6 | 6.8 | 7.1 |
| (N/mm²) | | | | |

¹⁾determined with Brookfield Viscometer, RVT measurement system, spindle #6, 20 rpm at 23° C.
²⁾storage stability determined by storage at 50° C. with the ICI Gel Strength Tester from Sheen Instruments, Ltd., data in scale divisions
³⁾cold water stability determined to DIN EN 204 D3
⁴⁾Wood Adhesives Temperature Test

1. A polyvinyl ester dispersion having a minimum film formation temperature of less than or equal to 10° C., comprising a polymerized and/or added crosslinker and a film formation assistant selected from the group of the esters of aliphatic monocarboxylic acids and at least trihydric aliphatic alcohols and/or of the esters of at least tribasic aliphatic carboxylic acids and monohydric aliphatic alcohols.

2. The polyvinyl ester dispersion as claimed in claim 1, characterized in that the polymerized crosslinker of the vinyl ester polymer comprises up to 10% by weight, based on the monomers used, of crosslinkable groups, preferably N-methylacrylamide groups.

3. The polyvinyl ester dispersion as claimed in claim 2, characterized in that the vinyl ester polymer is a vinyl acetate polymer.

4. The polyvinyl ester dispersion as claimed in claim 2, characterized in that low molecular weight crosslinkers and/or crosslinker resins have been added to the vinyl ester polymer.

5. The polyvinyl ester dispersion as claimed in claim 4, characterized in that the crosslinker resins are selected from the group of the resorcinol-formaldehyde resins, the urea-formaldehyde resins, the melamine-formaldehyde resins, the phenol-formaldehyde resins, the polyalkoxyalkyl- and polyalkanoldiazines, -triazines and -tetrazines, the imidazolidinones, the thioimidazolidinones, the hydroxymethyl-substituted imidazolidinones, the hydroxymethyl-substituted pyrimidinones, the hydroxymethyl-substituted triazinones or the self-condensation products or mixed condensates thereof, the derivatives from the group of the hydroxymethylated cyclic ethyleneureas which have been at least partly etherified with one or more alkanols, the cyclic propyleneureas, the bicyclic glyoxal diureas or the bicyclic malonaldehyde diureas.

6. The polyvinyl ester dispersion as claimed in claim 1, characterized in that it comprises at least one protective colloid.

7. The polyvinyl ester dispersion as claimed in claim 6, characterized in that the protective colloid is polyvinyl alcohol.

8. The polyvinyl ester dispersion as claimed in claim 1, characterized in that the film formation assistant is an ester of aliphatic monocarboxylic acids having from one to six carbon atoms, preferably acetic acid, with an at least trihydric aliphatic alcohol having from three to eight carbon atoms.

9. The polyvinyl ester dispersion as claimed in claim 8, characterized in that the at least trihydric aliphatic alcohol is trimethylolpropane, glycerol, pentaerythritol or sorbitol.

10. The polyvinyl ester dispersion as claimed in claim 9, characterized in that the at least trihydric aliphatic alcohol is glycerol.

11. The polyvinyl ester dispersion as claimed in claim 8, characterized in that the film formation assistant is a triester of glycerol with acetic acid, propionic acid or butyric acid, preferably triacetin.

12. The polyvinyl ester dispersion as claimed in claim 1, characterized in that it comprises
a) a polyvinyl ester homo- or copolymer which comprises 0.001-5% by weight of added crosslinker and/or 0.001-5% by weight of polymerized structural units derived from monomers having crosslinkable groups,
b) 1-20% by weight, based on the polyvinyl ester homo- or copolymer, of a protective colloid,
c) from 3 to 10% by weight, based on the sum of components a) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6.

13. The polyvinyl ester dispersion as claimed in claim 12, characterized in that it comprises
a) a polyvinyl ester homo- or copolymer which comprises 0.001-5% by weight of polymerized structural units derived from monomers having N-methylol groups,
a′) optionally 0.001-5% by weight of crosslinker which reacts with the N-methylol groups,
b) 1-20% by weight, based on the polyvinyl ester homo- or copolymer, of a protective colloid,
c) from 3 to 10% by weight, based on the sum of components a), a′) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6.

14. The polyvinyl ester dispersion as claimed in claim 1, characterized in that it comprises
a) a polyvinyl ester homo- or copolymer which optionally contains 0.001-5% by weight of polymerized structural units derived from monomers having N-methylol groups,
a) optionally 0.001-5% by weight of masked polyisocyanate or of masked polyfunctional aldehyde,
b) 1-20% by weight, based on the polyvinyl ester homo- or copolymer, of a protective colloid,
c) from 3 to 10% by weight, based on the sum of components a), a′) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6.

15. The polyvinyl ester dispersion as claimed in claim 12, characterized in that it comprises
a) a polyvinyl ester homo- or copolymer which comprises 0.001-5% by weight of polymerized monomers having crosslinkable N-methylol groups,
a′) 0.001 to 1% by weight of an additive which reacts with the crosslinkable N-methylol groups,
b) 1-20% by weight, based on the polyvinyl ester homo- or copolymer, of a protective colloid,
c) from 3 to 10% by weight, based on the sum of components a), a′) and b), of an ester of aliphatic monocarboxylic acids and at least trihydric aliphatic alcohols and/or of an ester of at least tribasic aliphatic carboxylic acids and monohydric aliphatic alcohols, and
d) optionally an acidic metal salt and/or an acid in a sufficient amount to establish a pH of 2-6.

16. The use of polyvinyl ester dispersions as claimed in claim 1 as adhesives, coating compositions or binders.

17. The use of esters of aliphatic monocarboxylic acids and at least trihydric aliphatic alcohols and/or of esters of at least tribasic aliphatic carboxylic acids and monohydric aliphatic alcohols as film formation assistants for adjusting the minimum film formation temperature of polymer dispersions.

18. The use as claimed in claim 17, characterized in that the film formation assistants are used in polyvinyl ester dispersions.
